(19) United States
(12) Patent Application Publication
(10) Pub. No.: US 2005/0029249 A1
(43) Pub. Date: Feb. 10, 2005

(54) Slow cooker

(75) Inventor: David J. Wanat, Meriden, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/881,748

(22) Filed: Jun. 30, 2004

Related U.S. Application Data
(60) Provisional application No. 60/483,618, filed on Jun. 30, 2003.

(51) Int. Cl. H05B 1/02; F27D 11/00

(52) U.S. Cl. 219/494; 219/492

(57) ABSTRACT

A slow cooker and method of cooking with a slow cooker is provided. The slow cooker has a base unit with a housing defining a heating chamber for heating and retaining a cooking basin placed therein, a lid for covering the cooking basin, and at least two cooking controls for controlling a time and a temperature for cooking at a first desired temperature and maintaining a cooked item at a second desired temperature. The method of cooking preferably includes at least two cooking controls cooperating to operate the slow cooker so that at the end of a cooking time at the first desired temperature set by the at least two cooking controls, the slow cooker operates to heat the cooking chamber to the second desired setting.

### CROSS-REFERENCE TO RELATED APPLICATIONS

This application claims priority to U.S. Provisional Patent Application Ser. No. 60/483,618 filed on Jun. 30, 2003, incorporated herein by reference in its entirety.

### BACKGROUND OF THE INVENTION

1. Field of the Invention

This invention relates to a slow cooker appliance. More particularly, the present invention relates to a slow cooker having at least two cooking controls for time and/or temperature cooking at a first desired temperature and maintaining a cooked item at a second desired temperature.

2. Description of the Related Art

There are various known slow cooker appliances for slow cooking food items over an extended period, typically a period of many hours. There are also slow cookers of the type having a programmable controller for controlling the cooking temperature and/or time parameters of the slow cooker. Generally, a common objective in the prior art devices is to cook food items placed in the slow cooker at a desired temperature or at the desired temperature for a fixed period of time.

However, operation of the prior art slow cookers is characterized by imprecise and inconvenient temperature and time controls. In particular, prior art slow cookers tend to operate at a fixed temperature for a fixed period of time.

Therefore, there exists a need to provide a slow cooker that is easily controlled and operated for cooking at a first desired temperature and time duration, and maintaining the cooked items in the slow cooker at a second desired temperature.

### SUMMARY OF THE INVENTION

It is an object of the present invention to provide a slow cooker at least two cooking controls for controlling time and/or temperature cooking at a first desired temperature and maintaining the cooking basin at a second desired temperature.

It is another object of the present invention to provide a slow cooker having a stable base.

It is yet another object of the present invention to provide a slow cooker having a rectangular exterior shape that makes the slow cooker is easy to store and transport.

It is a further object of the present invention to provide a slow cooker that has a base that is stable and easily storable and transportable.

It is yet a further object of the present invention to provide slow cooker is thus safer and more convenient to store and operate.

These and other objects and advantages of the present invention are realized by a slow cooker that has at least two cooking controls for controlling time and/or temperature cooking to control heating the cooking basin (i.e., cooking) at the first desired temperature setting and maintaining the cooking basin at the second desired temperature setting. The second desired temperature setting is preferably a WARM temperature setting/mode. The WARM mode temperature is a temperature setting for keeping the cooking basin at a temperature suitable for maintaining food items within the cooking basin at a palatable “serving” temperature with minimal or no further cooking of the food items.

### BRIEF DESCRIPTION OF THE DRAWINGS

The above and other objects, advantages, and benefits of the present invention will be understood by reference to following detailed description and appended sheets of drawings.

FIG. 1 is a perspective view of a slow cooker, including a lid, in accordance with the present invention;

FIG. 2 is a front view of the slow cooker shown in FIG. 1;

FIG. 3 is a side view of the slow cooker shown in FIG. 1;

FIG. 4 is a side view, opposite the side shown in FIG. 3, of the slow cooker shown in FIG. 1;

FIG. 5 is a top view of the slow cooker shown in FIG. 1; and

FIG. 6 is a flow diagram of an exemplary method of cooking in accordance with the present invention.

### DETAILED DESCRIPTION OF THE INVENTION

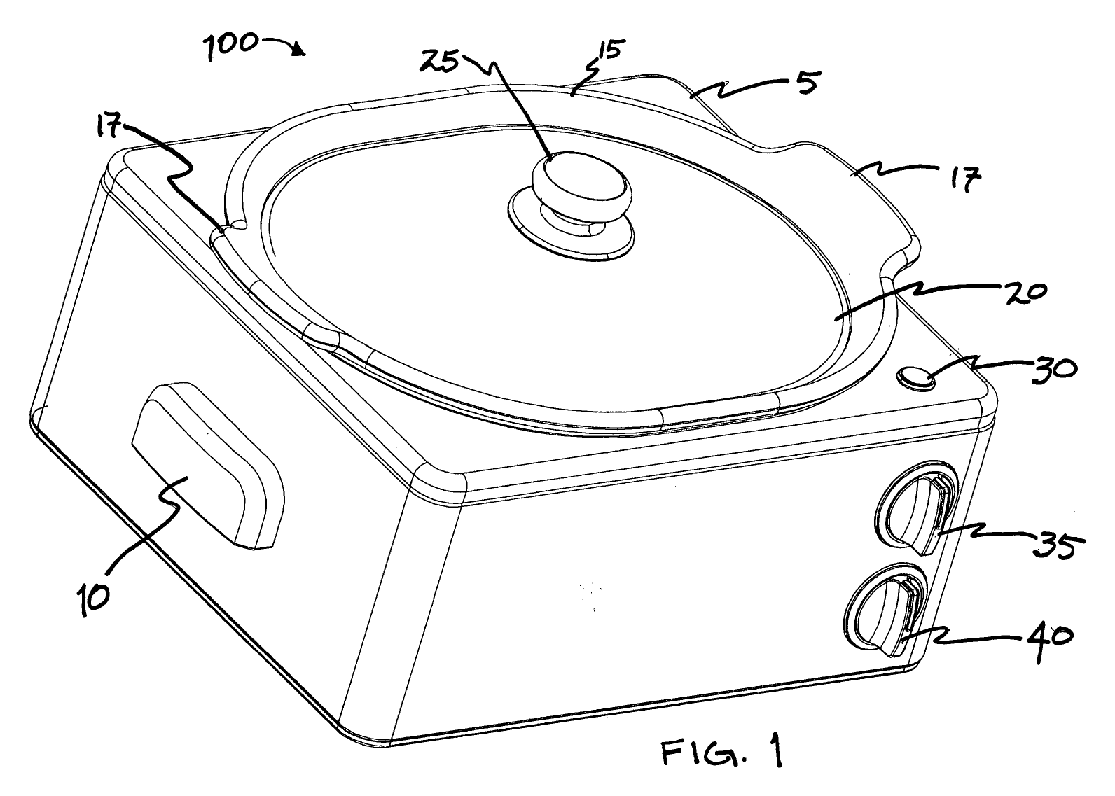

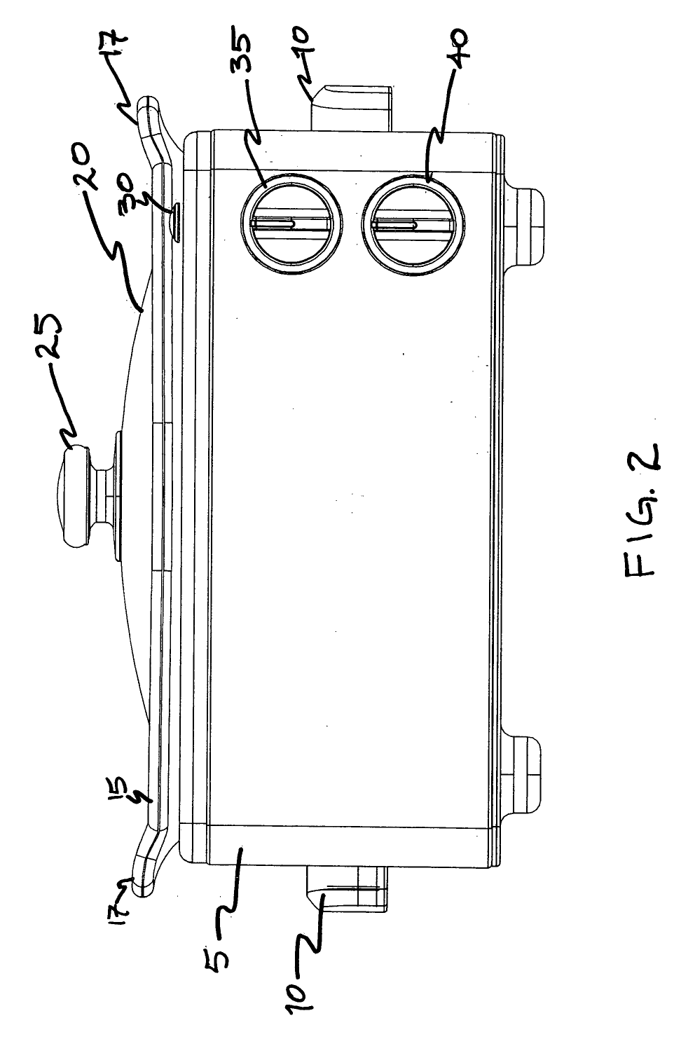

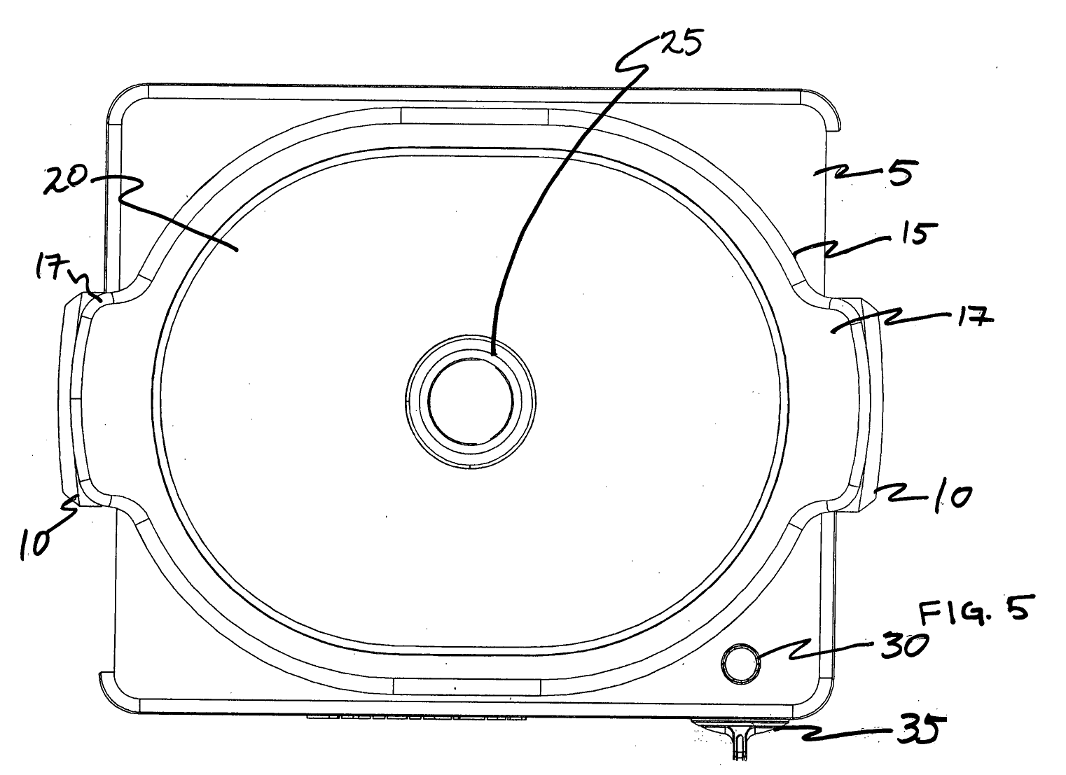

Referring to the drawings and, in particular, FIG. 1, there is shown generally a slow cooker represented by reference numeral 100. The slow cooker 100 includes a base unit 5 defining a heating chamber (not shown) for the heating and receiving of a heating or cooking basin 15 therein. As shown in FIGS. 1 to 5, heating basin 15 preferably has a lid 20 that matingly covers a food chamber defined by an interior of heating basin 15. Lid 20 preferably has a handle such as, for example, a lid handle 25 for conveniently placing lid 20 on top of heating basin 15. Food items cooked by slow cooker 100 are placed in the food chamber of heating basin 15. Heating basin 15 preferably has an annular lip at an upper edge of its upstanding walls. The annular lip matingly contacts an upper edge of the heating chamber such that the upper edge of the heating chamber supports heating basin 15. The annular lip of heating basin 15 preferably has handles 17 integrated therein.

Slow cooker 100 also has at least two cooking controls 35 and 40 for separately controlling time and/or temperature cooking at the first desired temperature and maintaining a cooked item at the second desired temperature. Cooking controls 35 and 40 each preferably control a parameter selected from the following parameters: a temperature setting, a time setting, or a timed temperature setting (i.e., heat the slow cooker to a particular temperature for a particular period of time). The specific parameter controlled by cooking controls 35 and 40 may vary. In an embodiment of the present invention, at least two cooking controls 35 and 40 are provided in order to provide an intuitive and uncluttered facility for controlling the cooking parameters of slow cooker 100.

In another embodiment of the present invention, cooking control 35 controls a temperature setting. Cooking control 35 is settable to a number of temperature settings. The temperature setting can include at least one specific temperature degree setting (e.g., 250°, 300°, etc.). The temperature settings preferably include, at least, a HI, a LO, and WARM setting.

Cooking control 40 preferably controls a timer that controls the time slow cooker 100 heats heating chamber and heating basin 15 (i.e., cooks) at the temperature selected by cooking control 35.

In yet another embodiment of the present invention, cooking controls 35 and 40 cooperatively operate, such that at the end of a cooking time set by cooking control 40 (i.e., time control), slow cooker 100 operates to heat heating basin 15 to the WARM temperature setting, i.e., WARM mode.

Cooking controls 35 and 40 operate in the above-described manner preferably notwithstanding a current temperature setting of cooking control 35 (i.e., temperature control) selected by cooking control 35. That is, whether cooking control 35 is set to Hi, Lo, WARM, or any other temperature setting, slow cooker 100 preferably commences to heat cooking basin 15 to the WARM temperature setting, i.e. WARM mode at the end of the selected cooking time. In this manner, slow cooker 100 can maintain food items cooked therein at a palatable, serving temperature at the end of a timed cooking session, without the intervention of a cook. Also, such a cooking method obviates the need for the cook to perfectly calculate their return to slow cooker 100 and/or the time the food items will be served.

The at least two cooking controls 35 and 40 can be rotary dials as FIGS. 1 to 5 or they can be implemented as any number of other controls such as touch-sensitive controls, toggle switches, push-buttons, LED control interfaces, LED control interfaces, and other analogous types of controls.

The at least two cooking controls 35 and 40 preferably have connected thereto associated circuitry for controlling the operation of a heater (not shown) that heats heating basin 15 to the desired, selectively set temperature setting. The associated circuitry preferably includes a thermostat technology suitable for regulating the heating of slow cooker 100. The thermostat technology may include a microprocessor, a thermistor, or other control circuitry for regulating the heating of slow cooker 100.

In another embodiment the present invention, a status indicator 30 is provided to communicate and/or indicate a status of the operation of slow cooker 100. For instance, the various exemplary status indications provided by status indicator 30 may include On, Heating (to selected temperature), Cooking (at selected temperature), WARM mode, and Off. The various status indications communicated by status indicator 30 may be conveyed by a color, intensity, and/or duration of status indicator 30. For example, the status of the operation of slow cooker 100 may depend on the color of status indicator 30 (e.g., amber, red, green, etc.), the intensity of the color (e.g., low or bright), and/or the duration of the status indication (e.g., constant, rapid flashing, or slow flashing).

In yet another embodiment of the invention, status indicator 30 may be implemented by a LCD or LED display, alone or in combination with a color, intensity, and/or duration component (such as that discussed above) for conveying the status of the operation of slow cooker 100. Status indicator 30 may have an audible component connected thereto for providing an audible indication, alone or in combination with another type of status indicator component, to convey the status of slow cooker 100.

In still yet another embodiment of the present invention, the exterior of the base unit 5 has a rectangular shape. The rectangular shape provides stability to slow cooker 100. For example, the weight of slow cooker 100, including any food item placed in heating basin 15, may be distributed over an area greater than the area provided by a base unit that follows the generally oval shape of cooking basin 15. Additionally, the exterior rectangular shape of base unit 5 housing makes a slow cooker 100 that is easy to store in, for example, a kitchen environment having generally orthogonal mating surfaces between the counter-tops and walls.

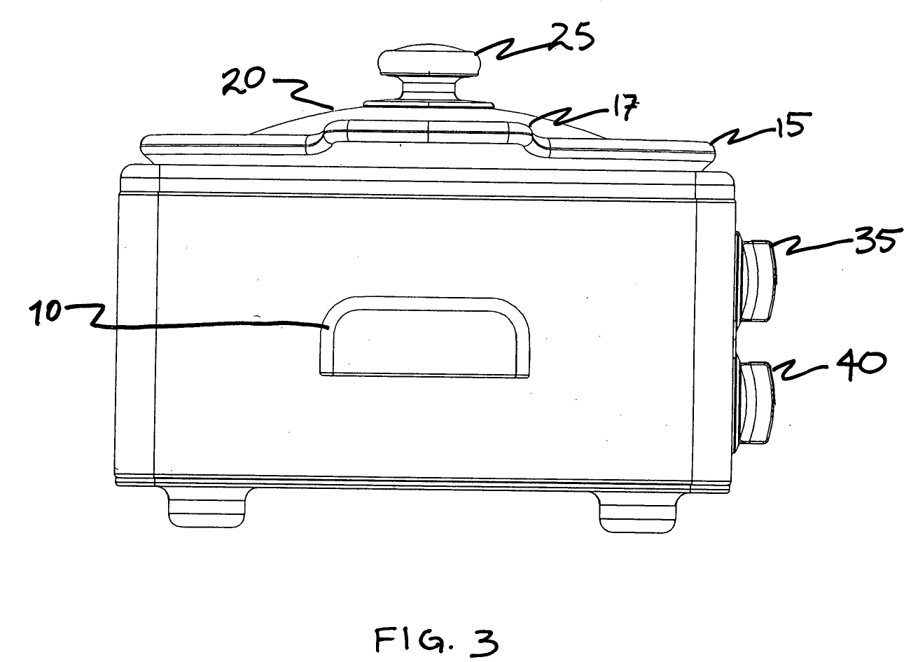

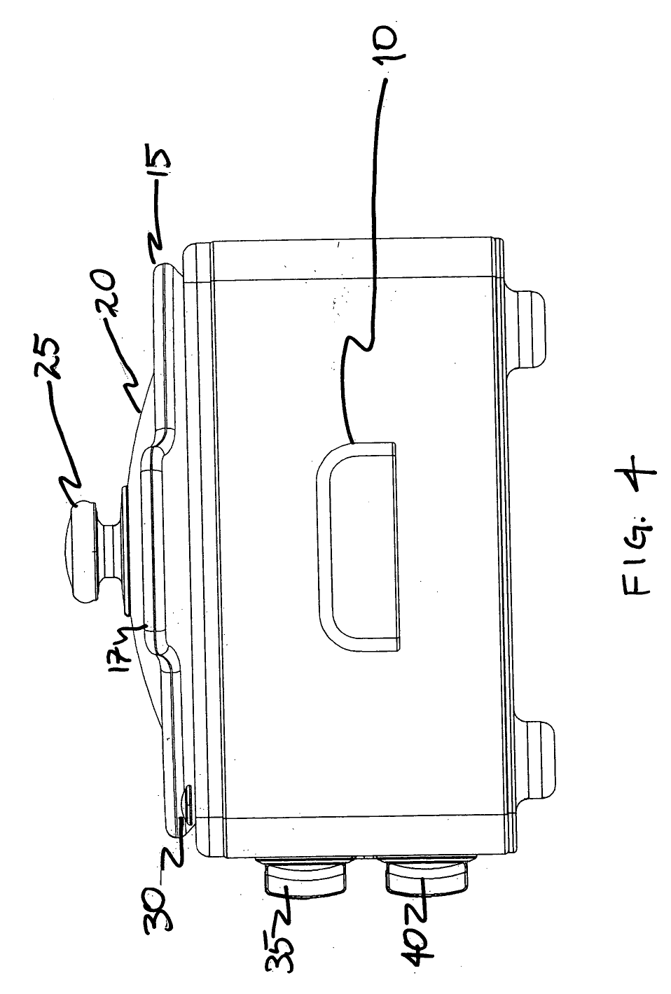

In a further embodiment of the present invention, base unit 5 includes handles 10. Preferably, one handle 10 is provided on each side of slow cooker 100 as shown in FIGS. 3 and 4. Handles 10 are preferably low-profile so as to require a minimum amount of storage clearance for slow cooker 100.

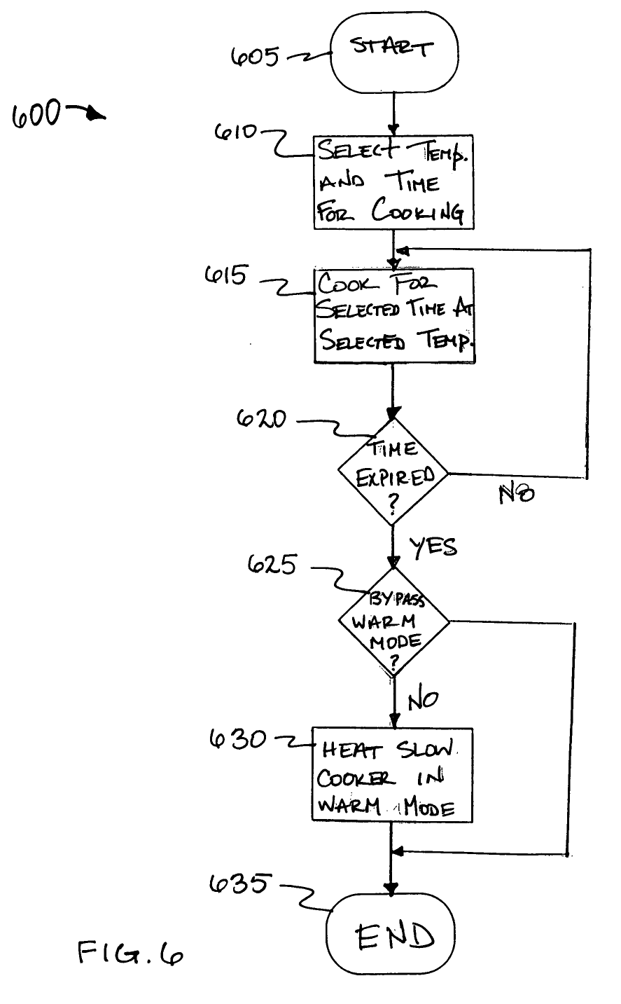

FIG. 6 illustrates an exemplary method of cooking 600 in accordance with the present invention. The exemplary cooking method 600 starts at step 605. Step 605 may include the steps of adding a food item(s) to slow cooker 100 by disposing the food item(s) into heating basin 15. The time setting and temperature setting are selected in step 610 using the at least two cooking controls 35 and 40.

Heating basin 15 is heated by the heater (not shown) controlled by cooking controls 35 and 40 to the temperature selected in step 615. Slow cooker 100 continues to heat heating basin 15 at the selected temperature until a determination is made at step 620 that the cooking time selected in step 615 has expired. In the instance it is determined at step 620 that the selected cooking time has not expired, then slow cooker 100 continues to cook at the selected temperature for the remainder of the selected period of cooking time by returning to step 615. In the instance that the selected cooking has expired, cooking method 600 proceeds to step 625.

At step 625, a determination is made by slow cooker 100 whether to bypass the WARM mode of operation. In a preferred embodiment of the present invention, the WARM mode is, by default, not bypassed at the expiration of the selected cooking time. In other words, slow cooker 100 preferably commences by default the WARM mode of operation upon the expiration of cooking at the selected temperature for the selected time period.

In the event that it is determined that the WARM mode is bypassed at step 625, cooking method 600 proceeds to 635, the end of the cooking method in which slow cooker 100 turns off. It is preferred that the bypassing of the WARM mode requires an affirmative action on the behalf of the cook that is cooking with slow cooker 100. For example, a bypass control or switch (not shown) can be included on slow cooker 100, the actuation of which causes the slow cooker to bypass the WARM mode of operation at the conclusion of the set timed duration of cooking at the set cooking temperature.

In the event that the WARM mode is not bypassed as determined at step 625, slow cooker 100 commences the WARM mode of operation at step 630. The WARM mode of operation heats heating basin 15 to a temperature setting suitable for maintaining the heating basin at a temperature conducive for maintaining food items within the cooking basin at a palatable “serving” temperature with little or no further cooking of the food items therein.

It should be appreciated that the cooking controls and configuration of slow cooker 100 discussed above are exemplary of the slow cooker of the present invention and do not preclude the inclusion, exclusion, and combination of other slow cooker controls and configurations.

It should also be appreciated by those skilled in the art that the particular slow cooker functions and other aspects of the teachings herein are but examples of the present invention, and thus do not limit the scope or variety of applications that the present invention may be suitably implemented. Thus, it should be understood that the foregoing description is only illustrative of a present implementation of the present invention. Those skilled in the art may devise various alternatives and modification without departing from the scope of the present invention. Accordingly, the present invention is intended to embrace all such alternatives, modifications, and variances, which fall within the scope of the appended claims.

1. A slow cooker comprising:
a heating chamber;
a heater for heating said heating chamber; and
a plurality of cooking controls for separately controlling a cooking time, a cooking temperature and, in combination, controls a relationship between said cooking time and said cooking temperature.

2. The slow cooker of claim 1, further comprising a heating basin for being received in and heated by said heating chamber.

3. The slow cooker of claim 1, wherein said plurality of cooking controls includes a first control for selectively controlling said cooking time and a second control for selectively controlling said cooking temperature.

4. The slow cooker of claim 3, wherein said plurality of cooking controls includes a bypass control for controlling at least one aspect of said relationship between said cooking temperature and said cooking time.

5. The slow cooker of claim 1, wherein said plurality of cooking controls comprises a bypass control for controlling at least one aspect of said relationship between said cooking temperature and said cooking time.

6. The slow cooker of claim 1, wherein said relationship includes a sequence of operation for said cooking temperature and said cooking time.

7. The slow cooker of claim 1, wherein said cooking temperature is selected from a group consisting of Hi, Lo, Warm, a specific temperature degree setting, and any combinations thereof.

8. The slow cooker of claim 1, further comprising a lid for substantially covering said heating chamber.

9. The slow cooker of claim 1, wherein said plurality of cooking controls are selected from a group consisting of a rotary knob, a toggle switch, a rocker switch, a LED control interface, a LCD control interface, a micro-switch, and any combinations thereof.

10. The slow cooker of claim 1, wherein the slow cooker has a base that has a substantially rectangular exterior shape.

11. The slow cooker of claim 1, further comprising a status indicator for communicating an operational status of the slow cooker.

12. The slow cooker of claim 1, further comprising a base having said heating chamber therein.

13. The slow cooker of claim 1, further comprising at least one handle located on the slow cooker.

14. A slow cooker comprising:
a heating chamber;
a heater for heating said heating chamber;
a first control for selectively controlling said cooking time; and
a second control for selectively controlling said cooking temperature, wherein said first and second controls control a cooking relationship between said cooking time and said cooking temperature to heat said heating chamber to a first desired temperature for a desired duration of time and, thereafter, maintain said heating chamber at a second desired temperature.

15. A method of cooking with a slow cooker, said method comprising:
selectively setting a cooking time with a first cooking control;
selectively setting a cooking temperature with a second cooking control;
heating a heating chamber to said set cooking temperature for a duration of said set cooking time; and
maintaining, in response to an end of said duration of said cooking time, of said heating chamber at a predetermined temperature.

16. The method of claim 15, further comprising determining whether said duration of said cooking time has ended.

17. The method of claim 15, further comprising determining whether said heating at said predetermined temperature is to be bypassed.

18. The method of claim 17, wherein said heating chamber is not heated to said predetermined temperature in response to a determination that said heating to said predetermined temperature is to be bypassed.

19. The method of claim 15, further comprising placing a food item in said heating chamber.

20. The method of claim 15, further comprising placing a food item in a heating basin placed in said heating chamber.

21. The method of claim 15, further comprising substantially covering said heating chamber with a lid.
